(19) United States
(12) Patent Application Publication
(10) Pub. No.: US 2009/0100261 A1
(43) Pub. Date: Apr. 16, 2009

(54) METHOD AND SYSTEM FOR MEDIATION OF AUTHENTICATION WITHIN A COMMUNICATION NETWORK

(76) Inventor: Hirokazu AOSHIMA, Machida (JP)

Correspondence Address: MCDERMOTT WILL & EMERY LLP, 600 13TH STREET, N.W., WASHINGTON, DC, 20005-3096, US

(21) Appl. No.: 12/209,659

(22) Filed: Sep. 12, 2008

(30) Foreign Application Priority Data
Sep. 28, 2007 (JP) 2007-253039

(51) Int. Cl. H04L 9/00; G06F 15/16

(52) U.S. Cl. 713/155; 709/229

(57) ABSTRACT

A method, a system, and a computer software product provide mediation of authentication within a communication network. The method comprises the steps of sending a request to mediate authentication between a first node 101; 410 and at least a second node 122; 420 from the first node to a mediation server 142; 450, receiving said request by the mediation server 142; 450, providing authentication between the mediation server 142; 450 and the second node 122; 420, providing mediation of authentication between the first node 101; 410 and the second node 122; 420, and establishing a connection between the first node 101; 410 and the second node 122; 420.

### REFERENCE TO RELATED APPLICATION

The present application claims priority from Japanese Patent Application No. 2007-253039 filed on Sep. 28, 2007, the entire contents of which are hereby incorporated by reference into this application.

1. Technical Field

The invention relates to a method and a system for mediation of authentication within a communication network between at least one first node managed by at least one first authentication server and at least one second node managed by at least one second authentication server using a mediation server.

2. Background

In modem communication networks and distributed systems authentication is one of the essential features for enabling safe service provision or/and access to resources. Authentication is required in order to avoid risks such as being manipulated by unexpected peers, giving information to unexpected peers, etc. So, it is very important to authenticate peers before a communication is set up with the peers.

In the prior art, substantially two methods have been proposed to achieve authentication between two peers. In the first method, the communication source node and the communication destination node exchange certificates of public keys. Such a certificate comprises the public key of the node together with a string that identifies the unit that the comprised public key belongs to. The unit could be, for example, a user, but also a host or a special device. The public key and the ID of the node must be signed by a certificate authority. This signature must also be part of the certificate. A signature is made using the private key of a certificate authority. It is assumed that the public key of the certificate authority is well-known. For example, several public keys of well-known certificate authorities are incorporated into today's web browsers and these public keys of the certificate authorities are distributed together with these programs. After the two communication nodes have received the certificate of the counter part node, they need to verify the validity and correctness of the certificate. This is done using the well-known public key of the certificate authority.

The major drawback of this approach is that the communication nodes need to know several public keys of certificate authorities. Furthermore, the nodes incur the load for decrypting the certificates. This poses especially a problem when a communication node needs to communicate with a lot of other nodes.

Therefore, it has been proposed to use so-called authentication servers. An authentication server keeps large tables in which it stores information about the nodes it manages. In general, these tables contain for each node the node ID, several attributes of the managed nodes like, for example, the certificate of the node, and in general also conditions that a counterpart node must meet in order to be able to communicate with the node.

The functionality of such an authentication server has been disclosed, for example, in US 2005/0 226 424 A1. In this prior art, the process of setting up a communication channel between a first communication node and a second communication node works as follows: First, the authentication server is authenticated at the communication node. Then, the communication node is authenticated at the authentication server.

The authentication server verifies the validity of the certificate of the communication node with the help of a validation server. After that, the communication node and the authentication server exchange commonly owned information plus an electronic signature to verify that both possess the private key that corresponds with the public key that they stated in their public key certificate. If all these security tests are successfully passed, the authentication server produces a symmetric key that it used as a session key between the communication node and the authentication server. In this way, an authenticated encrypted connection is set up. The same protocol is used to set up an authenticated encrypted communication channel between the authentication server and the communication node that the first communication node wants to communicate with. After having set up also this encrypted connection, the authentication server transmits the connection request from the first communication node to the second communication node. The second communication node judges as to whether or not the first communication node is permitted to connect to the second communication node.

The judgment result is given back to the authentication server. If the connection is permitted, the authentication server produces a session key that the first communication node and the second communication node should use for their encrypted communication. This session key is distributed from the authentication server to the first communication node and to the second communication node. Now, the two communication nodes can communicate with each other over an encrypted connection.

The major drawback of the described authentication server scenario is that it is not always true that all nodes are managed by a single authentication server. There are cases where nodes are managed by a plural of authentication servers that belong to different management domains. It is necessary for those authentication servers to cooperate in order to authenticate nodes managed by other authentication servers. It is also necessary to accept the management done by other servers in order to achieve such a cooperation. This means that authentication servers need to trust other authentication servers in a sense of management policy, trustworthiness of information managed by the servers and/or processes executed by the authentication servers.

### SUMMARY

It would be possible to establish mutual agreements between the authentication servers. However, if the number of authentication servers becomes big, the authentication servers must keep large tables of other well-known authentication servers. This would be inefficient in a large scale scenario. Accordingly, it is required to have a solution for such a situation.

An object of the invention is to provide a method, a system, and a computer software product for the secure cooperation of authentication servers that do not possess pre-established mutual agreements with each other.

This objective is accomplished by the features of the independent claims. Further aspects and preferred embodiments of the invention are defined by the dependent claims.

According to the invention a method for mediation of authentication within a communication network may be provided, wherein the method may comprise the steps of sending a request to mediate authentication between a first node and at least a second node from the first node to a mediation server, receiving said request by the mediation server, providing authentication between the mediation server and the second node, providing mediation of authentication between the first node and the second node, and/or establishing a connection between the first node and the second node.

With this method it is possible for two communication nodes to establish an authenticated and encrypted communication with each other, even if they belong to two different management domains.

The mediation server may comprise any computer programmed as a server or other means capable of performing the mediation operations. Furthermore, the mediation server may comprise a first authentication server and/or a second authentication server.

According to the invention the method for mediation of authentication within a communication network between at least one first node managed by at least one first authentication server and at least one second node managed by at least one second authentication server using a mediation server may comprise the steps of establishing an encrypted connection between the first node and the first authentication server, sending a request to establish an encrypted connection between the first node and the second node managed by the second authentication server from the first node to the first authentication server, providing a mediation server being able to mediate authentication between the first authentication server and the second authentication server, establishing an encrypted connection between the first authentication server and the mediation server, sending the request to establish a connection between the first node and the second node managed by the second authentication server from the first authentication server to the mediation server, establishing an encrypted connection between the mediation server and the second authentication server, sending an authentication request from the mediation server to the second authentication server, sending an authentication response from the second authentication server to the mediation server, mediating between the first authentication server and the second authentication server at the mediation server, distributing a mediation result from the mediation server to at least one of the first node and the second node, and/or establishing an encrypted connection between the first node and the second node.

In the sense of the invention, a server may be any means that is able to provide a service. A unit or module may be implemented in hardware and/or software, e.g. by a program running on a computer that runs server software.

According to the invention, there may exist only one mediation servers in the communication network or there may be a set of mediation servers. If there is more than one mediation servers present, which is able to mediate authentication between the first authentication server and the second authentication server, a mediation server must be selected. If there is only one mediation server present in the communication network, this mediation server is used to mediate authentication between the first authentication server and the second authentication server.

The method for mediation of authentication within a communication network according to the invention has the advantage that the authentication servers do not need to have a pre-established mutual agreement with each other. In fact, they do not even need to know each other. The authentication between the first authentication server and the second authentication server is performed by a mediation server. Thus, the authentication servers only need to be registered as a target for mediation at mediation servers in order to be able to set up an authenticated and encrypted connection with other formerly not known authentication servers. This allows to flexibly mediate authentication between different management domains. Especially, if the number of authentication servers is very large the approach of having mediation servers is more efficient. Without mediation servers the authentication servers would need to possess large tables that store information about other authentication servers like, for example, the certificates of the authentication servers.

Preferably, the step of establishing an encrypted connection between the first node and the first authentication server also comprises the additional steps of authenticating the first node at the first authentication server and/or authenticating the first authentication server at the first node. In general, these authentications can be done because the first node registered itself at the first authentication server and transmitted its certificate during this time. Also the first authentication server sent its certificate to the first node. By referring back to the certificate authority that issued the certificate the validity of the certificate can be verified. However, the invention is not restricted to a special way how certificates are issued, what they contain and how certificates are validated and verified. In fact, any viable method for authenticating may be used.

According to one embodiment of the invention, the request to establish an encrypted connection between the first node and the second node managed by the second authentication server comprises an identifier of the second node, an identifier of the second authentication server, and/or configuration information for the requested encrypted connection between the first node and the second node. The configuration information, for example, may contain a reference to a preferred encryption algorithm or a preferred encryption key length. The step of providing a mediation server may comprise any of the steps of sending a list of at least one mediation server where the first authentication server is registered as a target for mediation from the first authentication server to the second authentication server, selecting a mediation server where also the second authentication server is registered as a target for mediation from the list at the second authentication server, and/or sending an identifier of the selected mediation server from the second authentication server to the first authentication server.

In this way, the two authentication servers can negotiate a common mediation server at which both authentication servers are registered as a target for mediation. This method of negotiating is very easy. Only the two parties that are interested in the result of the negotiation are involved. Thus, the two parties are self-sufficient. A third party is not involved. Therefore, the likelihood of failures is reduced.

According to a very effective mode for carrying out the invention, the list of mediation servers is ordered according to a priority of the mediation servers. This means that the first authentication server states which mediation servers it prefers. The second authentication server can choose an appropriate mediation server based on the preferences of the first authentication server in combination with the preferences of the second authentication server. In this way, a suitable mediation server can be found.

The negotiation process may also comprise more than two messages. It is possible that the list of mediation servers that the first authentication server sends to the second authentication server does not contain a mediation server at which also the second authentication server is registered as a target for mediation. For example, the first authentication server proposes some, but not all of its preferable mediation servers in the list, since the first authentication server might be registered at so many mediation servers that listing them all in a single list would lead to a too long list. In such a case, if the second authentication server is unable to find any common mediation server in the list, the second authentication server may send a counter proposal of mediation servers or may ask for a further list of possible mediation servers. Then the first authentication server would respond to the second authentication server. In this way, the negotiation process may comprise more than two messages.

Preferably, the step of providing a mediation server is performed by using information about previous selections of mediation servers that is stored on the first authentication server. This means, each time the first authentication server receives a selection of the second authentication server concerning the selecting of a mediation server the first authentication server stores this selection. Whenever the first authentication server wants to find once again a mediation server that can mediate the authentication between the second authentication server and the first authentication server this stored information is used. This means that former selection decisions are cached in order to make selection processes faster. If cached information is available for a decision situation, there is no need to perform an intricate selection process.

Another way that the first authentication server may use to provide a mediation server is sending a request as to whether the mediation server can mediate the second authentication server to each mediation server using unicasting. In this approach, there is no need for the second authentication server to be involved into the selection process. This may be preferable, if one of the goals is to keep the workload at the second authentication server low.

The first authentication server may also provide a mediation server by sending a request as to whether the mediation server can mediate the second authentication server to each mediation server using broadcasting. This keeps the workload for the first authentication server low, because the first authentication server needs to send only one massage. However, this may lead to an excess of messages that are relayed within the network.

Therefore, the first authentication server may provide a mediation server by sending a request as to whether the mediation server can mediate the second authentication server to each mediation server using multicasting. Multicasting leads to a smaller number of messages in comparison to broadcasting. It may be especially well suited to use application layer multicasting. For example, a peer-to-peer substrate may be used to relay messages to the mediation servers.

In a preferred manner, the step of establishing an encrypted connection between the first authentication server and the mediation server further comprises the steps of authenticating the first authentication server at the mediation server and/or authenticating the mediation server at the first authentication server. This authentication may be performed using certificates of public keys. Preferably, the certificates are verified using the server of a certificate authority. However, the invention is not restricted to using a special protocol or a special method for authentication.

Preferably, the request to establish a connection between the first node and the second node managed by the second authentication server from the first authentication server to the mediation server further comprises an identifier of the first node, at least one attribute of the first node, and/or at least one condition that a counterpart node must meet to be able to communicate with the first node.

Advantageously, the step of establishing an encrypted connection between the mediation server and the second authentication server further comprises the steps of authenticating the mediation server at the second authentication server and/or authenticating the second authentication server at the mediation server.

Preferably, the authentication request that is sent from the mediation server to the second authentication server comprises an identifier of the second node. The second authentication server searches through its tables and finds out whether the second node is registered at the second authentication server. If this is the case, an authentication response is given back to the mediation server. Preferably, the authentication response comprises at least one attribute of the second node, at least one condition that a counterpart node must meet to be able to communicate with the second node, and/or configuration information for an encrypted connection with the second node.

Preferably, the step of mediating between the first authentication server and the second authentication server at the mediation server comprises the steps of determining if the first node is acceptable for the second node as a counter part of communication based on the at least one attribute of the first node and the at least one condition that a counter part node must meet to be able to communicate with the second node, determining if the second node is acceptable for the first node as a counter part of communication based on the at least one attribute of the second node and the at least one condition that a counter part node must meet to be able to communicate with the first node, determining the intersection between the configuration information sent from the first authentication server and the configuration information sent from the second authentication server, and/or determining a suitable configuration from the intersection as the mediation result.

In this way, a configuration is chosen that is suitable for both nodes. This means that both nodes are able to support the chosen configuration of an encrypted connection.

The mediation server may translate between the information model used to model the at least one attribute of the first node and the at least one condition that a counterpart node must meet to be able to communicate with the first node and the information model used to model the at least one attribute of the second node and the at least one condition that a counterpart node must meet to be able to communicate with the second node. The background of this functionality is that the first authentication server belongs to a first management domain and the second authentication server belongs to a second management domain. In different management domains different information models may be used. An information model is comparable to an ontology. The information model determines how attributes and conditions are expressed. The information model provides a vocabulary and concepts for expressing relevant information. A translation between the two information models may be necessary to deal with differences of the syntax or the semantics. Methods for translating between different information models are well-known from the prior art. Methods for such a translation are, for example, ontology mediation, ontology mapping, and/or schema matching.

Preferably, the mediation server retrieves on demand the at least one attribute of the first node, the at least one condition that a counterpart node must meet to be able to communicate with the second node, the at least one attribute of the second node, and/or the at least one condition that a counterpart node must meet to be able to communicate with the first node from the first and second authentication server during the step of mediating between the first authentication server and the second authentication server at the mediation server. This means that the mediation server retrieves only those parts of the information that is needed to determine a suitable mediation result. The on demand retrieval is done to prevent disclosing unnecessarily detailed information about nodes to the mediation server and/or to reduce data transmission between the authentication servers and the mediation server.

Preferably, the step of mediating between the first authentication server and the second authentication server at the mediation server further comprises the steps of generating an encryption key according to the determined configuration and adding the generated encryption key to the mediation result. The generated encryption key is a symmetric encryption key that is given to the first node and to the second node. Thus, the two nodes can use this encryption key for their encrypted communication. In comparison to asymmetric encryption methods symmetric encryption methods have the advantage that they need fewer computing cycles. This means that symmetric encryption is more efficient than asymmetric encryption.

The step of mediating between the first authentication server and the second authentication server at the mediation server may also comprise the steps of generating a seed of an encryption key according to the determined configuration and adding the generated seed of an encryption key to the mediation result. This means that instead of a complete encryption key only a seed of an encryption key is generated and added to the mediation result. Based on the seed the two nodes are able to derive the full encryption key.

Preferably, the step of distributing a mediation result from the mediation server to at least one of the first node and the second node comprises the steps of sending the mediation result from the mediation server to the first authentication server, sending the mediation result from the mediation server to the second authentication server, sending the mediation result from the first authentication server to the first node, and/or sending the mediation result from the second authentication server to the second node. This method of distribution is preferable because encrypted connections between the mediation server and the first and second authentication server already exist. Furthermore, an encrypted connection between the first authentication server and the first node already exists as well as an encrypted connection between the second authentication server and the second node. Thus, this way of distributing the mediation result reuses existing encrypted connections. As an alternative, it would be also possible that the mediation server sets up encrypted and authenticated connections between itself and the first node as well as an encrypted and authenticated connection between the mediation server and the second node. Then, the mediation result would be distributed over these connections. However, using this method entails setting up two new connections. As a further alternative, it would be possible that the mediation server issues a certificate that comprises the information that the second node can trust the first node. This certificate would be distributed to the first node. When the first node sets up the encrypted connection with the second node it sends this certificate to the second node. In this way the second node can verify the trustworthiness of the first node. In such a situation it may no longer be necessary to distribute the mediation result from the mediation server to the second node.

Preferably, the mediation result that is sent from the mediation server to the first authentication server and that is sent from the first authentication server to the first node further comprises an identifier of the second authentication server and/or an identifier of the second node.

Preferably, the mediation result sent from the mediation server to the second authentication server and sent from the second authentication server to the second node further comprises an identifier of the first authentication server and/or an identifier of the first node.

Preferably, the mediation request and/or the mediation result are recorded at the mediation server. Those records may be used to show what communication has been made between nodes.

Furthermore, the invention may comprise a system for mediation of authentication within a communication network, wherein the system comprises a unit for sending a request to mediate authentication between a first node and at least a second node from the first node to a mediation server, a unit for receiving said request by the mediation server, a unit for providing authentication between the mediation server and the second node, a unit for providing mediation of authentication between the first node and the second node, and/or a unit for establishing a connection between the first node and the second node.

Furthermore, the invention may comprise a system for the mediation of authentication within a communication network between at least one first node managed by at least one first authentication server and at least one second node managed by at least one second authentication server using a mediation server. The system comprises a unit for establishing an encrypted connection between the first node and the first authentication server, a unit for sending a request to establish an encrypted connection between the first node and the second node managed by the second authentication server from the first node to the first authentication server, a mediation server being able to mediate authentication between the first authentication server and the second authentication server, a unit for establishing an encrypted connection between the first authentication server and the mediation server, a unit for sending the request to establish a connection between the first node and the second node managed by the second authentication server from the first authentication server to the mediation server, a unit for establishing an encrypted connection between the mediation server and the second authentication server, a unit for sending an authentication request from the mediation server to the second authentication server, a unit for sending an authentication response from the second authentication server to the mediation server, a unit for mediating between the first authentication server and the second authentication server at the mediation server, a unit for distributing a mediation result from the mediation server to the first node and to the second node, and/or a unit for establishing an encrypted connection between the first node and the second node.

According to the invention the first node may be constituted by a user. Also the second node may be constituted by a user.

Preferably, the first and second authentication server keep information about each node that they manage comprising at least one attribute of the managed node, and/or at least one condition that a counterpart node must meet to be able to communicate with the managed node.

Preferably, the first and second authentication server furthermore keep information about each counterpart authentication server that they have a pre-agreed relation with comprising at least one attribute of the counterpart authentication server and/or at least one condition in order to manage nodes cooperatively between the authentication servers. If the first authentication server possesses a pre-agreed relation with another authentication server where the second node is registered, no mediation server is needed. In this way, an encrypted connection between the first node and the second node can be set up more quickly. However, a large-scale system that is flexible should not rely on pre-agreed relations between authentication servers.

Preferably, the first and second authentication server keep information about at least one mediation server comprising at least one attribute of the mediation server and/or information which enables the authentication server to authenticate the mediation server.

The information which enables the authentication server to authenticate the mediation server may be a public key certificate of the mediation server.

Preferably, the mediation server keeps information about each authentication server that is registered as a target for mediation at the mediation server comprising at least one attribute of the authentication server and/or information which enables the mediation server to authenticate the authentication server.

The information which enables the mediation server to authenticate the authentication server may be a public key certificate of the authentication server.

Other concepts relate to unique software for implementing the techniques for mediation of authentication. A software product, in accord with such a concept, includes at least one machine-readable medium (e.g. a storage medium) and information carried by the medium. The information carried by the medium may be executable program code, one or more databases and/or information regarding implementation of the mediation technique.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The drawing figures depict one or more implementations in accord with the present teachings, by way of example only, not by way of limitation. In the figures, like reference numerals refer to the same or similar elements.

Features, embodiments, and particular aspects of the invention are explained in the following with reference to the drawings.

FIG. 1 shows a scenario for the mediation of authentication within a communication network.

FIG. 2 shows the tables that one embodiment of an authentication server comprises.

FIG. 3 shows the tables that one embodiment of a mediation server comprises.

FIG. 4 shows one embodiment of a system for mediation of authentication within a communication network.

FIG. 5 shows a first embodiment of the method for mediation of authentication within a communication network.

FIG. 6 shows a second embodiment of the method for mediation of authentication within a communication network.

FIGS. 7 and 8 are functional block diagrams of general purpose computer platforms.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings.

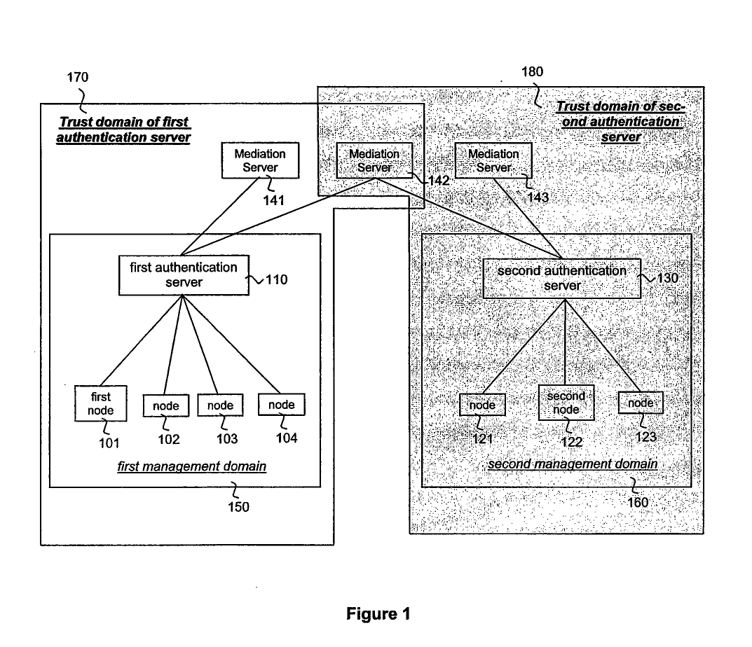

FIG. 1 shows a scenario for the mediation of authentication within a communication network. The first authentication sever 110 manages several nodes 101, 102, 103, 104. The first authentication server 110 and the nodes it manages 101, 102, 103, 104 are contained within the first management domain 150. The first node 101 wants to communicate via an encrypted connection with the second node 122. However, the second node 122 is located in a second management domain 160.

The second management domain 160 comprises the second authentication server 130 and the nodes that are managed by the second authentication server 121, 122, 123. There is no pre-established mutual agreement between the first authentication server 110 and the second authentication server 130. Thus, mediation of authentication is needed. The first authentication server 110 is registered as a target for mediation at several mediation servers 141, 142. There is trust established between the mediation servers 141, 142 and the first authentication server 110. Thus, the two mediation servers 141, 142 and the first management domain 150 collectively constitute a trust domain of the first authentication server 170. Also, the second authentication server 130 is registered as a target for mediation at various mediation servers 142, 143. There is a trust relation established between the second authentication server 130 and the mediation servers 142, 143. Thus, the two mediation servers 142, 143 and the second management domain 160 collectively constitute the trust domain of the second authentication server 180. The goal of the invention is to combine two trust domains 170, 180.

This combination of the trust domains can be reached by mediating authentication between the first authentication server 110 and the second authentication server 130. This mediation can be performed by the mediation server 142 where the first authentication server 110 is registered as a target for mediation as well as the second authentication server 130. This means that the first authentication server 110 and the second authentication server 130 have the same mediation server 142 in common. This means, both authentication servers trust the mediation server 142. This is the basic principle how mediation of authentication can be performed.

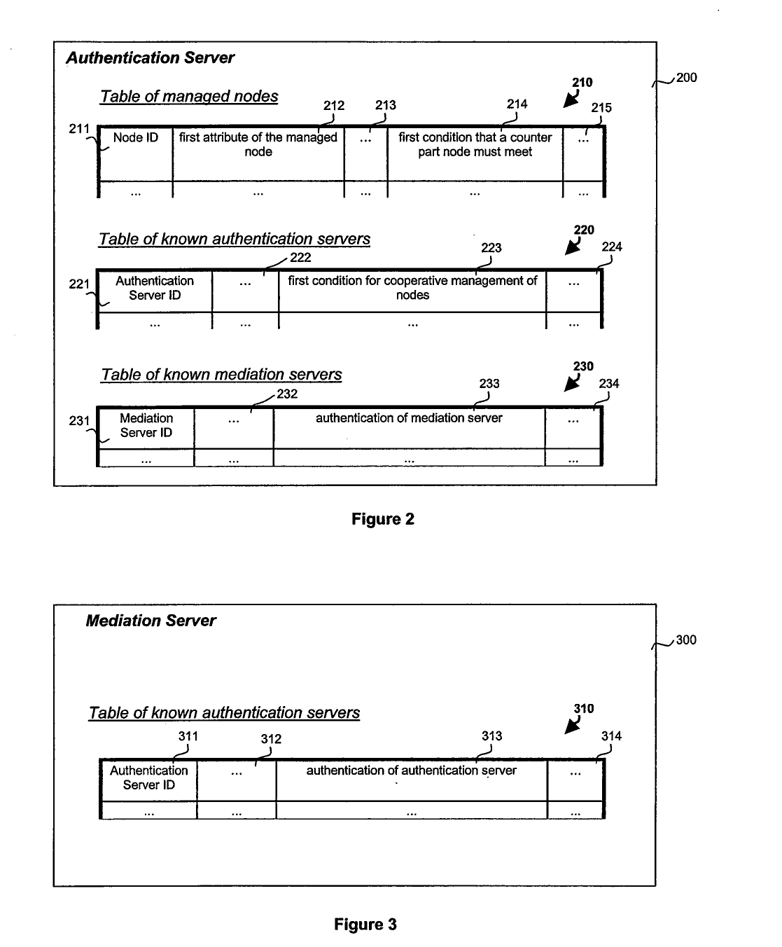

FIG. 2 shows one embodiment of an authentication server 200. This embodiment of the authentication server comprises a table of managed nodes 210, a table of known authentication servers 220, and a table of known mediation servers 230.

The table of managed nodes 210 comprises several columns 211, 212, 213, 214, 215. One column 211 contains the identifier of the node (node ID). Another column 212 comprises the first attribute of the managed node. Additional columns 213 may contain further attributes of the managed node. A further column 214 comprises a first condition that a counterpart node must meet in order to communicate with the node that is represented by the node ID. Further columns 215 may contain further conditions that a counterpart node must meet.

The table of known authentication servers 220 comprises several columns. One column 221 comprises an authentication server identifier (authentication server ID). Further columns 222 may contain further attributes of the authentication server. A further column 223 comprises the first condition for cooperative management of nodes. Further columns 224 may contain further conditions for cooperative management of nodes.

The table of known mediation servers 230 comprises several columns. One column 231 contains the identifier of the mediation server (mediation server ID). Further columns 232 may comprise further attributes of the mediation server. One column comprises the authentication of the mediation server referenced by the mediation server ID. Further columns 234 may comprise further information about the mediation server.

FIG. 3 shows one embodiment of a mediation server 300. The embodiment of the mediation server 300 comprises a table of known authentication servers 310. The table of known authentication servers 310 comprises several columns. One column 311 contains an identifier of the authentication server (authentication server ID). Further columns 312 may comprise further attributes of the authentication server. One column 313 comprises an authentication of the authentication server referenced by the identifier of the authentication server. Further columns 314 may comprise further information about the authentication server.

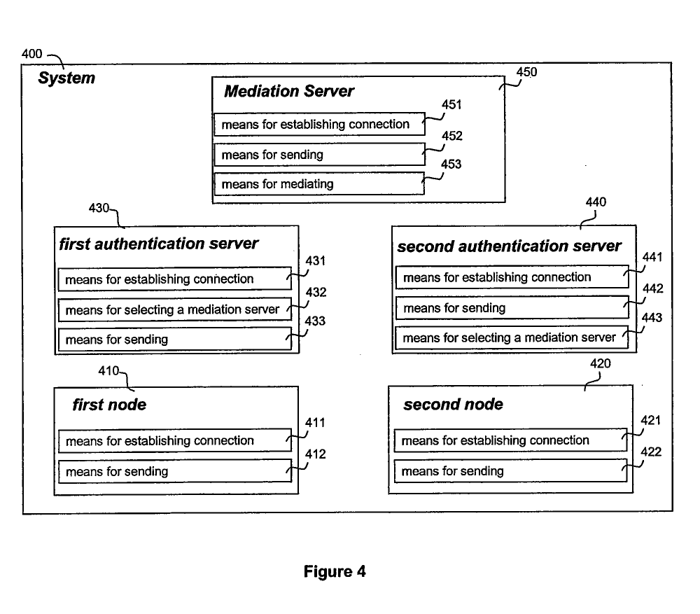

FIG. 4 shows one embodiment of a system for mediation of authentication within a communication network. The embodiment of the system 400 comprises a first node 410, a second node 420, a first authentication server 430, a second authentication server 440, and a mediation server 450. The system 400 comprises a means (unit or module) for establishing an encrypted connection between the first node and the first authentication server 411, 431. This unit comprises a module for establishing an encrypted connection 411 that is located on the first node 410 and a module for establishing an encrypted connection 431 that is located on the first authentication server 430. The first node 410 further comprises a unit for sending a request 412 to establish an encrypted connection between the first node and the second node managed by the second authentication server from the first node to the first authentication server. The first authentication server 430 further comprises a unit for selecting a mediation server 432 being able to mediate authentication between the first authentication server 430 and the second authentication server 440. The system 400 further comprises a unit for establishing an encrypted connection between the first authentication server and the mediation server 431, 451. This means comprises a unit for establishing an encrypted connection 431 that is located on the first authentication server 430 and a unit for establishing an encrypted connection 451 that is located on the mediation server 450. The first authentication server 430 further comprises a unit for sending the request 433 to establish a connection between the first node and the second node managed by the second authentication server from the first authentication server to the mediation server 450.

The system 400 further comprises a unit for establishing an encrypted connection between the mediation server 450 and the second authentication server 440. This unit comprises a module for establishing an encrypted connection 451 that is located on the mediation server 450 and a second module for establishing an encrypted connection 441 that is located on the second authentication server 440. The system 400 further comprises a unit for sending an authentication request 452 from the mediation server to the second authentication server 440. The second authentication server 440 further comprises a unit for sending an authentication response 442 from the second authentication server 440 to the mediation server 450. Furthermore, the second authentication server 440 comprises a unit for selecting a mediation server 443. Thus, also the second authentication server can select a mediation server if the second node wants to establish an authenticated and encrypted connection with a node that is managed by a different authentication server. The mediation server 450 further comprises a unit or module for mediating 453 between the first authentication server and the second authentication server at the mediation server 450.

The system 400 further comprises a unit for distributing 433, 442, 452 a mediation result from the mediation server 450 to the first node 410 and to the second node 420. This unit comprises a module for sending 452 located on the mediation server 450, a module for sending 433 located on the first authentication server 430, and a module for sending 442 located on the second authentication server 440. The system 400 further comprises a unit for establishing an encrypted connection between the first node and the second node. This unit comprises a module for establishing an encrypted connection 411 that is located on the first node 410 and a module for establishing an encrypted connection 421 that is located on the second node 420. Additionally, the second node 420 comprises also a unit for sending 422.

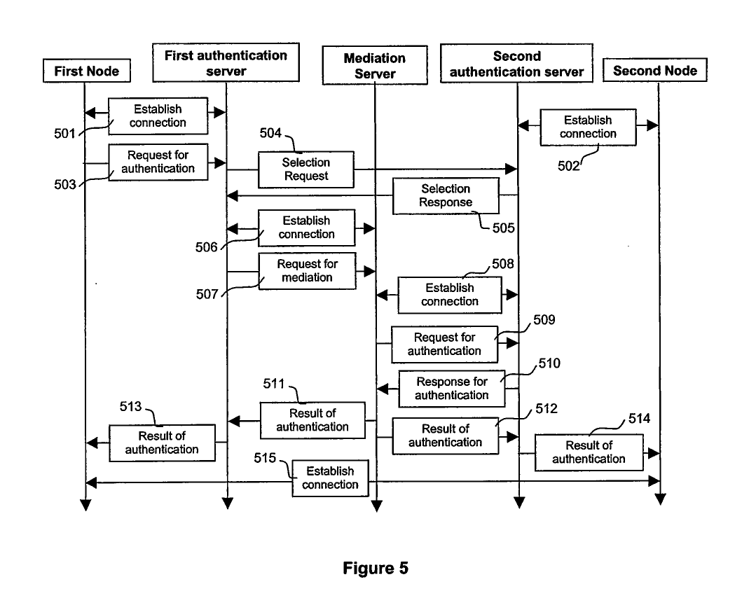

FIG. 5 shows one embodiment of the method for mediation of authentication within a communication network. In step 501 the first node authenticates itself at the first authentication server and the first authentication server authenticates itself at the first node. Afterwards, the first node and the first authentication server establish an encrypted connection for communication between them. For the authentication and the establishing of an encrypted connection the method disclosed in US 2005/0226424 A1 can be used. However, the invention is not restricted to using this method. Any other method for authenticating two parties and for establishing an encrypted connection can be used. In step 502 the second node authenticates itself at the second authentication server and the second authentication server authenticates itself at the second node. Afterwards, the second authentication server and the second node establish an encrypted connection between them. In step 503 the first node sends a request to establish an encrypted connection between the first node and the second node managed by the second authentication server from the first node to the first authentication server. This request comprises an identifier of the second node, an identifier of the second authentication server, and configuration information for an encrypted connection between the first node and the second node.

The first authentication server receives the request from the first node. There may be three cases:

1. The first case is that the second node is also managed by the first authentication server.

2. The second case is that the second node is managed by the second authentication server and the first authentication server possesses a pre-established mutual agreement with the second authentication server.

3. The third case is that the second node is managed by the second authentication server and the first authentication server does not possess a pre-established mutual agreement with the second authentication server. This is the case in the embodiment of the method for mediation of authentication that is shown in FIG. 5. In this case the first authentication server needs to select an appropriate mediation server. This selection is accomplished in the current embodiment as follows:

In step 504 the first authentication server sends a selection request to the second authentication server. This selection request comprises a list of at least one mediation server where the first authentication server is registered as a target for mediation. When the second authentication server receives the selection request message, it selects a mediation server from the list where also the second authentication server is registered as a target for mediation. In step 505 the second authentication server sends a selection response to the first authentication server. This selection response message comprises an identifier of the selected mediation server. Here, it is assumed that this selection process is done by just one round trip of messages. It is also conceivable that the selection process is done in a more complex selection process. In this case more than two messages would be exchanged between the first authentication server and the second authentication server. It is also possible that the first authentication server adds priorities to the list of mediation servers where the first authentication server is registered as a target for mediation. This means that the list of mediation servers is sorted. Mediation servers with a high rank in the list are very preferable from the point of view of the first authentication server. Mediation servers with a low rank in the list are still possible to use, but they are not preferable from the point of view of the first authentication server. The second authentication server would then choose a mediation server from the list under consideration of the priorities of the first authentication server and under consideration of the priorities of the second authentication server.

In step 506 the first authentication server authenticates itself at the selected mediation server and the selected mediation server authenticates itself at the first authentication server. Afterwards, the first authentication server and the mediation server establish an encrypted connection between them. In step 507 the first authentication server sends a request for mediation to the mediation server. This request comprises an identifier of the second node, an identifier of the second authentication server that manages the second node, an identifier of the first node, attributes of the first node, conditions that a counter part node must meet to be able to communicate with the first node, and configuration information for an encrypted connection between the first node and the second node. When the selected mediation server receives the request for mediation, the mediation server checks whether the second authentication server is registered as a target for mediation at the mediation server. This is necessary for the mediation server to be able to serve mediation services. If the second authentication server is registered as a target for mediation at the selected mediation server the selected mediation server authenticates itself at the second authentication server and the second authentication server authenticates itself at the mediation server. Afterwards, the mediation server and the second authentication server establish an encrypted connection between each other (step 508).

In step 509 the selected mediation server sends a request for authentication to the second authentication server. This request for authentication comprises an identifier of the second node. When the second authentication server receives the request for authentication, it checks whether the second node is one of the nodes that the second authentication server manages. This is accomplished by checking the table of managed nodes that is stored on the second authentication server. If the second node is managed by the second authentication server, the second authentication server sends a response for authentication to the selected mediation server in step 510. This response for authentication comprises attributes of the second node, information about conditions that a counterpart node must meet to be able to communicate with the second node, and configuration information for an encrypted connection with this second node. When the selected mediation server receives the response for authentication, the mediation server authenticates both nodes. Furthermore, it mediates between the first authentication server and the second authentication server. This mediation is done by performing the following steps:

First, it is determined if the first node is acceptable for the second node as a counter part of communication based on the at least one attribute of the first node and the at least one condition that a counter part node must meet to be able to communicate with the second node. In a second step, it is determined if the second node is acceptable for the first node as a counter part of communication based on the at least one attribute of the second node and the at least one condition that a counter part node must meet to be able to communicate with the first node. In a third step, the intersection between the configuration information sent from the first authentication server and the configuration information sent from the second authentication server is determined. From this intersection a suitable configuration is determined as the mediation result.

This means that the mediation server does the following: It finds out what the requirements are when a node wants to communicate with the first node. And it checks whether the second node can meet these requirements. Then it finds out what the requirements are when a node wants to communicate with the second node and checks whether the first node can meet these requirements. Then the mediation server chooses the configuration for the encrypted connection between the first node and the second node in such a way that both nodes are able to take part in the encrypted communication and in such a way that the requirements of both nodes are met. The chosen configuration is the mediation result.

During this mediation process it might happen that the first authentication server and the first node express their attributes, their conditions, their requirements and other information in an information model that is different from the information model that is used by the second node and by the second authentication server. This means that the requirements of the node in the first management domain are not directly comparable to the attributes of the second node. Thus, a translation is needed. The mediation server is able to translate from one information model to the other information model. In this way it is accomplished that the mediation server can mediate authentication between two management domains that do not use the same information model. This translation of the syntax or semantics of information can be performed, for example, by ontology mediation, ontology mapping, and/or schema matching. These methods are well known from the prior art.

During the mediation process it is also possible that attributes of the nodes and conditions that a counter part node must meet to be able to communicate with the node are retrieved on demand. This means that the mediation server requests information only when it is really needed for the decision which configuration should be chosen. This retrieval on demand is beneficial because it prevents disclosing unnecessarily detailed information. In this way data transmission is reduced.

The selected configuration chosen by the mediation server determines for example which encryption algorithm should be used between the first node and the second node and how long the encryption key should be. After a configuration has been chosen the mediation server generates an encryption key according to the configuration. Instead of generating an encryption key the mediation server may also generate a seed of an encryption key. Based on the seed, the first node and the second node are able to derive the encryption key. This means that both the first node and the second node know a general method how an encryption key can be generated based on a seed of an encryption key. The generated encryption key or the seed of the encryption key is added to the mediation result.

Then the mediation server distributes the mediation result that also comprises the encryption key or the seed of the encryption key. In step 511 the selected mediation server sends a result of authentication to the first authentication server. This result of authentication comprises an identifier of the second node, an identifier of the second authentication server, and the mediation result which comprises a configuration for an encrypted connection between the first node and the second node and a generated key or the seed of an encryption key. In step 512 the mediation server sends another result of authentication to the second authentication server. This result of authentication comprises an identifier of the first node, an identifier of the first authentication server, and the mediation result comprising a configuration for an encrypted connection between the first node and the second node and a generated key or a seed of a key. In step 513 the first authentication server forwards the result of authentication that it received from the selected mediation server in step 511 to the first node. In step 514 the second authentication server forwards the result of authentication that it received in step 512 from the mediation server to the second node. At this point both the first node and the second node have received the mediation results and an identifier of the counter part authentication server and the counter part node. In step 515 the first node and the second node establish an encrypted connection between them using the identifier of the counter part node of the communication, the identifier of the counter part authentication server, the selected configuration for an encrypted connection, and the generated encryption key or the generated seed of an encryption key.

A person skilled in the art can easily see that the steps 504 and 505 can be replaced when the first authentication server had earlier interactions with the second authentication server. This means that the first authentication server already holds a selection of a mediation server made by the second authentication server in its cache that states which mediation server can be used to mediate authentication between the first authentication server and the second authentication server. This cached information can be reused to select a mediation server.

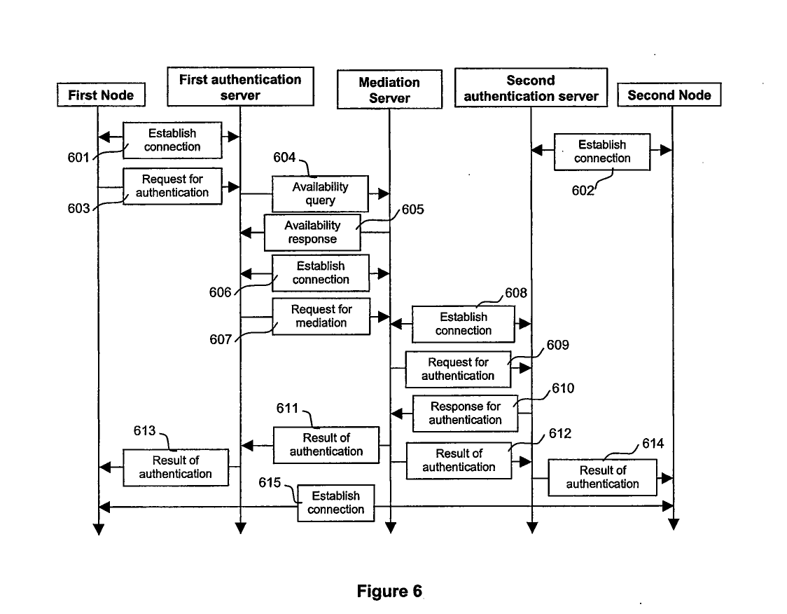

FIG. 6 shows another embodiment of the method for mediation of authentication within a communication network. In step 601 the first node authenticates itself at the first authentication server, the first authentication server authenticates itself at the first node, and both nodes establish an encrypted connection between them. In step 602 the second node authenticates itself at the second authentication server, the second authentication server authenticates itself at the second node, and the second node and the second authentication server establish an encrypted connection between each other. In step 603 the first node sends a request for authentication to the first authentication server. The request for authentication comprises at least an identifier of the second node, an identifier of the second authentication server, and configuration information for the requested encrypted connection between the first node and the second node.

When the first authentication server receives the request for authentication, it tries to find a mediation server that can mediate authentication between the first authentication server and the second authentication server. Thus, in step 604 the first authentication server sends an availability query to at least one mediation server. This sending of the availability query to at least one mediation server can be performed using unicasting, broadcasting, multicasting, or any other method of sending messages within a communication network. Especially, using application layer multicasting based on a peer-to-peer substrate would be preferable. The availability query comprises at least an identifier of the second node and an identifier of the second authentication server. The availability query asks the mediation server as to whether it is possible to mediate the authentication between the second authentication server and the first authentication server. When the availability query is received by a mediation server that is able to mediate authentication between the first authentication server and the second authentication server, it sends an availability response to the first authentication server in step 605. This availability response comprises at least an identifier of the mediation server sending this availability response. This means that the mediation server states to the first authentication server that it is able and willing to mediate authentication between the second authentication server and the first authentication server. Thus, the first authentication server receives in the case where a suitable mediation server can be found at least one availability response. The first authentication server selects a mediation server from the one received availability response or the numerous received availability responses.

In step 606 the first authentication server authenticates itself at the selected mediation server and the selected mediation server authenticates itself at the first authentication server. Afterwards, the first authentication server and the mediation server establish an encrypted connection. In step 607 the first authentication server sends a request for mediation to the mediation server. In step 608 the selected mediation server authenticates itself at the second authentication server and the second authentication server authenticates itself at the mediation server. Afterwards, the mediation server and the second authentication server establish an encrypted connection between each other. In step 609 the mediation server sends a request for authentication to the second authentication server. If the second authentication server manages the second node, it sends a response for authentication in step 610. After having received the response for authentication the mediation server mediates between the first authentication server and the second authentication server. The mediation server selects a suitable configuration for an encrypted connection between the first node and the second node. Based on this configuration the mediation server generates an encryption key or a seed of an encryption key. The mediation result comprising at least the selected configuration for an encrypted connection between the first node and the second node and an encryption key or a seed of an encryption key is distributed to the first node and the second node. In step 611 the mediation result, an identifier of the second authentication server, and an identifier of the second node is sent to the first authentication server from the mediation server. In step 612 the mediation server sends the mediation result, an identifier of the first authentication server, and an identifier of the first node to the second authentication server. In step 613 the first authentication server forwards the information that it received in step 611 from the mediation server to the first node. In step 614 the second authentication server sends the information that it received in step 612 from the mediation server to the second node. In step 615 the first node and the second node establish an encrypted connection between them using the identifier of the counter part node, the identifier of the counter part authentication server, the configuration for an encrypted connection, and the generated encryption key or the seed of the generated encryption key.

Summarizing the above, the method for mediation of authentication within a communication network according to the invention allows to establish an authenticated and encrypted connection between a first node and a second node even when the first node and the second node are managed by different authentication servers that belong to different management domains. Even if the first authentication server and the second authentication server do not have any pre-established mutual agreement between each other, they are capable of interacting with each other in an authenticated way. The necessary authentication to establish a trust relationship is mediated by the mediation server.

As shown by the above discussion, functions relating to the mediation of authentication within a computer network may be implemented on computers or other programmable elements connected for data communication via the components of a packet data network, operating as a mediation server and/or as an authentication server as shown in FIG. 1. Although special purpose devices may be used, such elements also may be implemented using one or more hardware platforms intended to represent a general class of data processing device commonly used to run “server” programming so as to implement the functions discussed above, albeit with an appropriate network connection for data communication.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. files used for the authentication and/or mediation functions. The software code is executable by the general-purpose computer that functions as the server and/or that functions as a terminal device. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for distinguishing a live actor from an automation, in essentially the manner performed in the implementations discussed and illustrated herein.

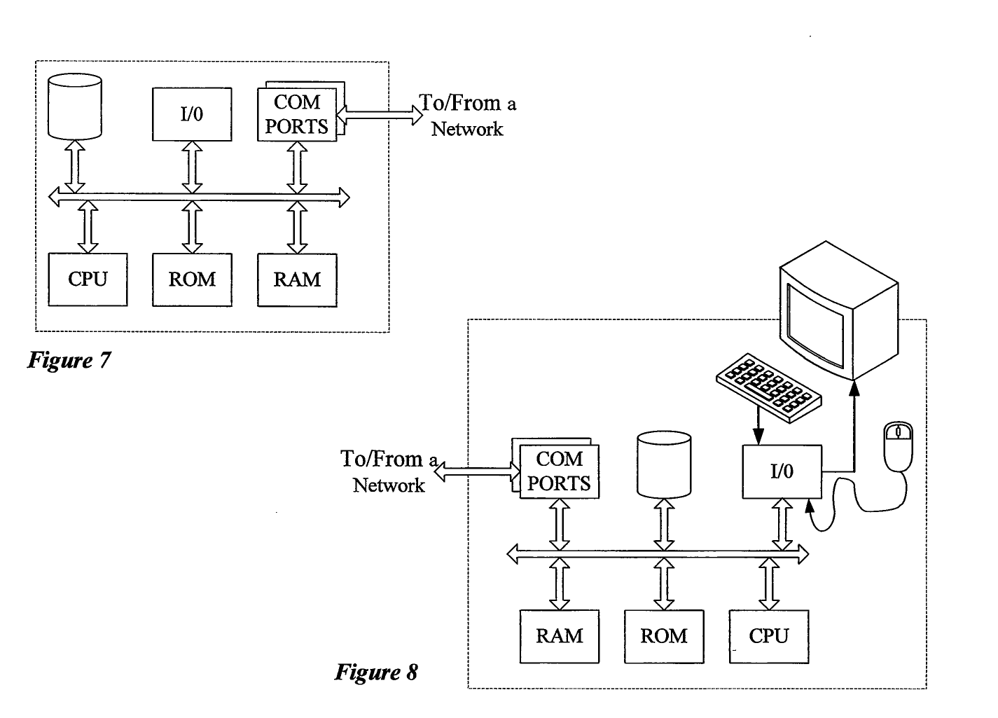

FIGS. 7 and 8 provide functional block diagram illustrations of general purpose computer hardware platforms. FIG. 7 illustrates a network or host computer platform, as may typically be used to implement a server. FIG. 8 depicts a computer with user interface elements, as may be used to implement a personal computer or other type of work station or terminal device, although the computer of FIG. 8 may also act as a server if appropriately programmed. It is believed that those skilled in the art are familiar with the structure, programming and general operation of such computer equipment and as a result the drawings should be self-explanatory.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load.

Hence, aspects of the methods of authentication and mediation thereof outlined above may be embodied in programming. Program aspects of the technology may be thought of as “products” or “articles of manufacture” typically in the form of executable code and/or associated data that is carried on or embodied in a type of machine readable medium. “Storage” type media include any or all of the memory of the computers, processors or the like, or associated modules thereof, such as various semiconductor memories, tape drives, disk drives and the like, which may provide storage at any time for the software programming. All or portions of the software may at times be communicated through the Internet or various other telecommunication networks. Such communications, for example, may enable loading of the software from one computer or processor into another, for example, from a management server or host computer of the network operator or other service provider into the computer platform of the mediation server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement any one or more of the servers, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

The specifications and drawings are to be regarded in an illustrative rather than a restrictive sense. It is evident that various modifications and changes may be made thereto without departing from the spirit and scope of the invention as set forth in the claims.

While the invention has been described with reference to different embodiments above, this description shall not limit the disclosure or features and aspects of the present invention. In this regard, as far as modifications are readily apparent for an expert skilled in the art they shall be included by the above description of embodiments implicitly. For example, while the content of the exchanged messages has been described, it may also be possible to use the method according to the invention by exchanging messages with different contents. Furthermore, the order of the exchanged messages may be different. It is also possible that for the mediation process different information is used to find a suitable match between the first node and the second node.

What is claimed is:

1. Method for mediation of authentication within a communication network wherein a first node is managed by a first authentication server, a second node is managed by a second authentication server, and the method comprises the steps of:
authenticating the first node at the first authentication server,
authenticating the first authentication server at the first node,
sending a request to mediate authentication between the first node and at least the second node from the first node to the first authentication server,
providing a mediation server being able to mediate authentication between the first node and the second node,
authenticating the first authentication server at the mediation server,
authenticating the mediation server at the first authentication server,
sending the request to mediate authentication between the first node and the second node from the first authentication server to the mediation server,
authenticating the second authentication server at the mediation server,
authenticating the mediation server at the second authentication server,
providing authentication between the second authentication server and the second node,
providing mediation of authentication between the first node and the second node by distributing a mediation result from the mediation server to at least one of the first node and the second node, and
establishing a connection between the first node and the second node.

2. The method according to claim 1, wherein the request to mediate authentication between the first node and the second node comprises:
an identifier of the second node,
an identifier of the second authentication server, and
configuration information for a connection between the first node and the second node.

3. The method according to claim 1, wherein the step of providing the mediation server comprises the steps of:
sending a list of at least one mediation server where the first authentication server is registered as a target for mediation from the first authentication server to the second authentication server,
selecting a mediation server where also the second authentication server is registered as a target for mediation from the list at the second authentication server, and
sending an identifier of the selected mediation server from the second authentication server to the first authentication server.

4. The method according to claim 3, wherein the list of mediation servers is ordered according to a priority of the mediation server.

5. The method according to claim 1, wherein the step of providing the mediation server comprises sending several messages between the first authentication server and the second authentication server.

6. The method according to claim 1, wherein the step of providing the mediation server is performed by using information about previous selections of a mediation server that is stored on the first authentication server.

7. The method according to claim 1, wherein the first authentication server provides the mediation server by sending a request as to whether the mediation server can mediate the second authentication server to each mediation server using unicasting.

8. The method according to claim 1, wherein the first authentication server provides a mediation server by sending a request as to whether the mediation server can mediate the second authentication server, to each mediation server using broadcasting.

9. The method according to claim 1, wherein the first authentication server provides a mediation server by sending a request as to whether the mediation server can mediate the second authentication server, to each mediation server using multicasting.

10. The method according to claim 1, wherein:
the request to mediate authentication between the first node and the second node from the first authentication server to the mediation server comprises:
an identifier of the first node,
at least one attribute of the first node, and
at least one condition that a counter part node must meet to be able to communicate with the first node.

11. The method according to claim 1, wherein the step of providing authentication between the mediation server and the second node comprises the steps of:
sending an authentication request from the mediation server to the second authentication server, and
sending an authentication response from the second authentication server to the mediation server.

12. The method according to claim 11, wherein the authentication request comprises an identifier of the second node.

13. The method according to claim 1, wherein the authentication response comprises:
at least one attribute of the second node,
at least one condition that a counter part node must meet to be able to communicate with the second node, and
configuration information for a connection with the second node.

14. The method according to claim 1, wherein the step of providing mediation of authentication between the first node and the second node comprises the steps of:
determining if the first node is acceptable for the second node as a counter part of communication based on the at least one attribute of the first node and the at least one condition that a counter part node must meet to be able to communicate with the second node,
determining if the second node is acceptable for the first node as a counter part of communication based on the at least one attribute of the second node and the at least one condition that a counter part node must meet to be able to communicate with the first node,
determining the intersection between the configuration information sent from the first authentication server and the configuration information sent from the second authentication server, and
determining a suitable configuration from the intersection as the mediation result.

15. The method according to claim 14, wherein the mediation server translates between the information model used to model the at least one attribute of the first node and the at least one condition that a counter part node must meet to be able to communicate with the first node and the information model used to model the at least one attribute of the second node and the at least one condition that a counter part node must meet to be able to communicate with the second node.

16. The method according to claim 14, wherein the mediation server retrieves on demand the at least one attribute of the first node, the at least one condition that a counter part node must meet to be able to communicate with the second node, the at least one attribute of the second node, and the at least one condition that a counter part node must meet to be able to communicate with the first node from the first and second authentication server during the step of providing mediation of authentication between the first node and the second node.

17. The method according to claim 1, wherein the step of providing mediation of authentication between the first node and the second node further comprises the steps of:
generating an encryption key according to the determined configuration, and
adding the generated encryption key to the mediation result.

18. The method according to claim 1, wherein the step of providing mediation of authentication between the first node and the second node further comprises the steps of:
generating a seed of an encryption key according to the determined configuration, and
adding the generated seed of an encryption key to the mediation result.

19. The method according to claim 1, wherein the step of distributing a mediation result form the mediation server to at least one of the first node and the second node comprises the steps of:
sending the mediation result from the mediation server to the first authentication server,
sending the mediation result from the mediation server to the second authentication server,
sending the mediation result from the first authentication server to the first node, and
sending the mediation result from the second authentication server to the second node.

20. The method according to claim 19, wherein the mediation result sent from the mediation server to the first authentication server and sent from the first authentication server to the first node comprises:
an identifier of the second authentication server, and
an identifier of the second node.

21. The method according to claim 20, wherein the mediation result sent from the mediation server to the second authentication server and sent from the second authentication server to the second node comprises:
an identifier of the first authentication server, and
an identifier of the first node.

22. The method according to claim 1, wherein the request to mediate authentication between the first node and the second node and/or the mediation result are recorded at the mediation server.

23. A system for mediation of authentication within a communication network comprising a first node being managed by a first authentication server and a second node being managed by a second authentication server, wherein the system comprises:
a unit for authenticating the first node at the first authentication server,
a unit for authenticating the first authentication server at the first node,
a unit for sending a request to mediate authentication between the first node and at least the second node from the first node to the first authentication server,
a mediation server being able to mediate authentication between the first node and the second node,
a unit for authenticating the first authentication server at the mediation server,
a unit for authenticating the mediation server at the first authentication server,
a unit for sending the request to mediate authentication between the first node and the second node from the first authentication server to the mediation server,
a unit for authenticating the second authentication server at the mediation server,
a unit for authenticating the mediation server at the second authentication server,
a unit for providing authentication between the second authentication sever and the second node,
a unit for providing mediation of authentication between the first node and the second node by distributing a mediation result from the mediation server to at least one of the first node and the second node, and
a unit for establishing a connection between the first node and the second node.

24. The system according to claim 23, wherein the first node is constituted by a user.

25. The system according to claim 23, wherein the second node is constituted by a user.

26. The system according to claim 23, wherein the first and second authentication servers keep information about each node that they manage, the information comprising:
at least one attribute of the managed node, and/or
at least one condition that a counter part node must meet to be able to communicate with the managed node.

27. The system according to claim 23, wherein the first and second authentication servers keep information about each counter part authentication server that they have a pre-agreed relation, the information comprising:
at least one attribute of the counter part authentication server, and/or
at least one condition in order to manage nodes cooperatively between the authentication servers.

28. The system according to claim 23, wherein the first and second authentication servers keep information about at least one mediation server, the information comprising:
at least one attribute of the mediation server, and/or
information which enables the authentication server to authenticate the mediation server.

29. The system according to claim 28, wherein the information which enables the authentication server to authenticate the mediation server is a public key certificate of the mediation server.

30. The system according to claim 23, wherein the mediation server keeps information about each authentication server that is registered as a target for mediation at the mediation server, the information comprising:
at least one attribute of the authentication server, and/or
information which enables the mediation server to authenticate the authentication server.

31. The system according to claim 30, wherein the information which enables the mediation server to authenticate the authentication server is a public key certificate of the authentication server.

32. An article of manufacture, comprising:
a machine readable storage medium; and
programming instructions embodied in said medium for execution by at least one computer, wherein execution causes said at least one computer to perform functions comprising:
authenticating the first node at the first authentication server,
authenticating the first authentication server at the first node,
sending a request to mediate authentication between the first node and at least the second node from the first node to the first authentication server,
providing a mediation server being able to mediate authentication between the first node and the second node,
authenticating the first authentication server at the mediation server,
authenticating the mediation server at the first authentication server,
sending the request to mediate authentication between the first node and the second node from the first authentication server to the mediation server,
authenticating the second authentication server at the mediation server,
authenticating the mediation server at the second authentication server,
providing authentication between the second authentication server and the second node,
providing mediation of authentication between the first node and the second node by distributing a mediation result from the mediation server to at least one of the first node and the second node, and
establishing a connection between the first node and the second node.
